(19) United States
(12) Patent Application Publication
(10) Pub. No.: US 2019/0245781 A1
(43) Pub. Date: Aug. 8, 2019

(54) HOST DETECTION METHOD FOR NETWORK SWITCH AND SYSTEM THEREOF

(71) Applicant: ESTINET TECHNOLOGIES INC., Hsinchu (TW)

(72) Inventors: Chia-Ching Yang, Tainan City (TW); CHIEN-HSIN CHEN, Tainan City (TW)

(21) Appl. No.: 16/154,225

(22) Filed: Oct. 8, 2018

(30) Foreign Application Priority Data
Feb. 2, 2018 (TW) 107103843

(51) Int. Cl. H04L 12/721; H04L 12/715; H04L 12/741; H04L 12/931; H04L 29/12

(52) U.S. Cl. CPC H04L 45/38; H04L 45/64; H04L 61/2007; H04L 49/70; H04L 45/66; H04L 45/745

(57) ABSTRACT

The disclosure is related to a host detection method for a network switch and a system thereof. When an SDN switch is online, flow entries, priority 100 and priority 310 with a meter used to filter ARP packets, are added to the switch. When packets are received by the SDN switch from a host, the host's MAC address and IP address can be learned by an SDN controller using the above flow entries. A metering of flow entries allow the number of packets entering a central processor of the switch to be controlled for reducing workload. Flow entries, priority 110 and priority 330, having the same number as detected hosts, are added. The counting results are used to determine whether each host is online or not. Further, the MAC address and IP address of the host can be updated.

### FIELD OF THE DISCLOSURE

The disclosure is related to a technology for host detection applied to a network switch, and in particular to a method and a system for host detection operated with a network switch and a flow table mechanism so that the loading of a CPU can be reduced.

### BACKGROUND OF THE DISCLOSURE

FIG. 1 shows a framework of a network system including a network switch. An SDN (Software-Defined Network) switch 10 shown in the diagram includes electronic components for implementing various functions. The electronic components are interconnected via a data bus or circuits. The SDN switch 10 has a control IC 104 that is used to operate this SDN switch 10. The control IC 104 connects an SDN controller 12 via a management interface 106. Further, the control IC 104 establishes a connection with a LAN 14 through a network unit 105 (PHY) so as to form a topology of a Software-Defined Network.

A central processor 101 is electrically connected with its peripheral circuits. The central processor 101 executes a software switch 102 for conducting exchanging and routing of network packets. While processing the network packets, both the central processor 101 and the memory 103 handle a huge load of work such as storing and clearing. Further, the work over a control plane between the SDN switch 10 and the SDN controller 12 may also be added to the workload of the central processor 101 and the memory 103, so that the loading applied to the electronic components such as the central processor 101 and the memory 103 is increased.

The internal circuits of the SDN switch 10 are schematically described in FIG. 2. The main components of the SDN switch 10 are such as the central processor 101 and the control IC 104. The control IC 104 is in charge of operating the switch 10. The control IC 104 includes a meter 221 that is used to control the number of packets. The control IC 104 is connected with the central processor 101 via the data bus 21. When the central processor 101 receives the packets, the packets are temporarily buffered to a buffer 201. After the packets are processed by a core operating system 23, the packets enters a queue 202 of the central processor 101. The packets stored in a buffer 203 through the queue 202 are provided for a software switch 204, or alternatively the packets stored in a buffer 205 are monitored by a monitoring process 206.

In the conventional SDN, an OpenFlow protocol is used between the SDN switch 10 and the SDN controller. The OpenFlow protocol uses three message types such as a packet-in message, a flow-mod message and a packet-out message to implement communication there-between. For example, when the SDN switch 10 processes the packet-in message, the central processor 101 is required to perform multiple accessing sequences and process the information with respect to the processor 101. The SDN switch may therefore have unreliability problems since the central processor 101 may suffer from a too high loading when processing a huge number of packets.

### SUMMARY OF THE DISCLOSURE

The disclosure is related to a host detection method for a network switch and a system thereof. A rule in compliance with an OpenFlow protocol is provided for interconnecting an SDN switch with an SDN controller. Functions of metering and counting can also be provided with a configuration of flow entries of a flow table in a software switch. This scheme successfully achieves loading reduction of a central processor of the SDN switch.

According to one of the embodiments of the host detection method, when an SDN switch goes online, a first flow entry with a meter is firstly added. For example, a priority 100 flow entry can be firstly added, and a second flow entry used to match ARP packets, e.g. a priority 310 flow entry, can also be added.

When receiving packets from one or more hosts, the SDN controller can learn the MAC addresses of the one or more hosts through the priority 100 flow entry and the priority 310 flow entry. Meter is performed within a timeout period. For example, the SDN controller controls the number of packets entering the central processor of the SDN switch by a meter, thereby reducing the loading of the central processor.

After that, the same number of the third flow entries as the detected hosts are added. The third flow entry is such as a priority 110 flow entry. A counter is used to count the packets that match a priority 110 flow entry. A counting result allows the SDN controller to detect if the host is online. The same number of the fourth flow entries as the detected hosts are added. The fourth flow entry is such as priority 330 flow entry that is used to update the MAC address and IP address of the host.

When the counting result no longer changes or the counter is insufficient, the SDN switch will issue an ARP request packet to the host. An ARP reply packet from the host can be referred to to determine if the host is online. In this case, a fifth flow entry is added to the SDN switch. The fifth flow entry is such as priority 340 flow entry that allows the SDN controller to receive an ARP reply packet.

Through the records of the abovementioned flow entries, it can be detected whether the hosts are in online or offline state, and the loading of the central processor of the SDN switch can be simultaneously reduced.

According to one of the embodiments of the disclosure, the aforementioned flow entries are:

a first flow entry (priority 100): having no match fields;

a second flow entry (priority 310): matching on ARP packet;

a third flow entry (priority 110): matching on Source MAC Address;

a fourth flow entry (priority 330): matching on Sender Hardware Address and Sender Protocol Address in ARP packet; and

a fifth flow entry (priority 340): matching on Target Hardware Address in ARP packet.

The disclosure is further related to a host detection system. In one embodiment, the system includes an SDN switch and an SDN controller that form a network system. The host detection method described above can be operated in the SDN controller that can communicate with the SDN switch in compliance with an

### OpenFlow Protocol.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the detailed description and the accompanying drawings, in which:

FIG. 1 describes an electrical structure of a conventional network switch;

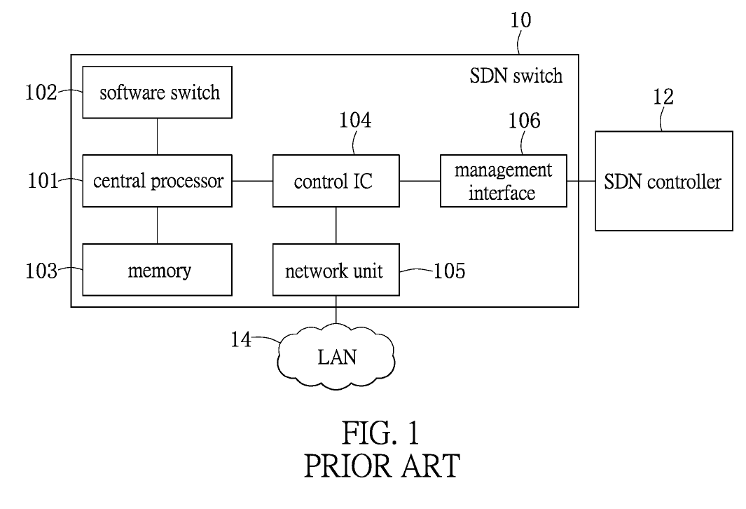

FIG. 2 schematically describes an architecture of a conventional SDN switch applied to a host detection method in accordance with one embodiment of the disclosure;

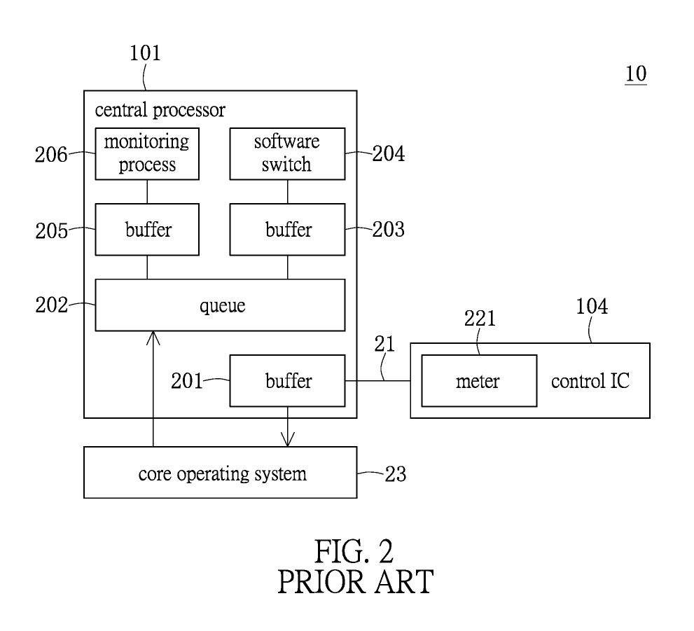

FIG. 3 shows a flow chart illustrating the host detection method for a network system by using flow entry according to one embodiment of the disclosure;

FIG. 4 shows a flow chart illustrating an initial operating process in the host detection method in one embodiment of the disclosure;

FIG. 5 shows a flow chart describing the host detection method for a network switch according to one embodiment of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The present invention will now be described more fully with reference to the accompanying drawings, in which preferred embodiments of the invention are shown. This invention may, however, be embodied in many different forms and should not be construed as being limited to the embodiments set forth herein; rather, these embodiments are provided so that this disclosure will be thorough and complete, and will fully convey the scope of the invention to those skilled in the art.

The disclosure is related to a host detection method for a network switch, and a host detection system for implementing the method. One of the objectives of the host detection method is to solve the problem of overburdening of the processor of the network switch. The network switch is such as a Software-Defined Network (SDN) switch.

According to one embodiment of the disclosure, the host detection method is operated in an SDN switch. The network switch can also be a Legacy & SDN Hybrid Switch. The Software-Defined Network utilizes a centralized SDN controller to replace a control plane of a conventional switch in a distributed network system. The SDN switch in the Software-Defined Network is only in charge of a data plane. Therefore, the centralized controller can optimize the control plane. When the network switch performs the host detection method, the SDN controller will take over the operation. In one aspect of the disclosure, the SDN controller communicates with the SDN switch through an OpenFlow protocol so as to acquire the host status and perform the host detection method.

The processor of the network switch is in charge of processing the packets in the switch. A huge amount of memory is required to conduct the processes of copying and cleaning the data. In an exemplary example, the SDN switch conducts the exchanging of packets and instructions, e.g. the packet-in packets, with the SDN controller. Some actions will be required for repeatedly accessing and clearing the processor and memory.

One further objective of the host detection method for software switch is to solve the drawback of overloading applied to the central processor 101 of SDN switch 10 when the SDN switch 10 processes the network packets and tasks with the SDN controller 12 simultaneously. One aspect of the invention is utilizing the flow entries of a flow table operated in the software switch 102 to detect whether the host is online or offline. Therefore, the number of packet-in messages can be decreased so as to reduce the loading of the central processor 101.

The technology of detecting whether the host is online or offline can be implemented by metering and counting packets generated by the host. The flow entry of the flow table in the switch can cooperate with the meter or counter for detecting the host's status. The information of OSI Layer 2 or MAC layer of the packets and Address Resolution Protocol (ARP) packets allow the network switch to detect the host's status. An SDN controller can be specified to conduct host detection if the network switch is an SDN switch.

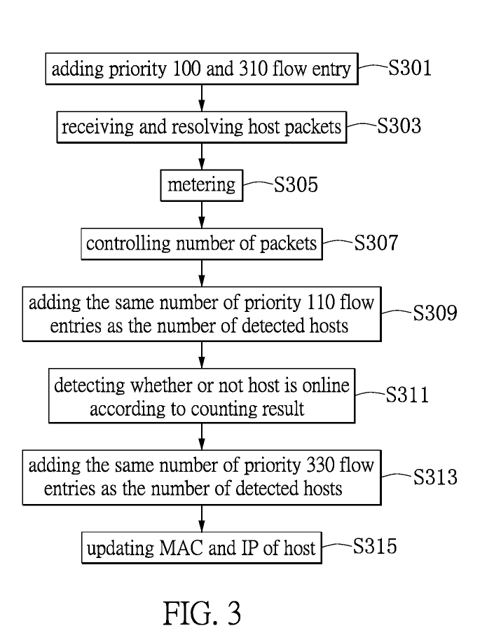

The information such as obtaining the flow entry from the network switch for determining whether the host is online or offline can be referred to a flow chart of FIG. 3 and is described as follows. In one embodiment of the disclosure, various flow entries recorded in a flow table stored in a memory of the network switch are provided for an SDN controller to work with the network switch. The host detection method is performed through instructions that are executed by a processor of the network switch. It should be noted that the number of flow entries are not limited to the following description.

The flow entries are:

a first flow entry (priority 100): having no match fields;

a second flow entry (priority 310): matching on ARP packet;

a third flow entry (priority 110): matching on Source MAC Address;

a fourth flow entry (priority 330): matching on Sender Hardware Address and Sender Protocol Address in ARP packet; and

a fifth flow entry (priority 340): matching on Target Hardware Address in ARP packet.

The definitions for the flow entries applied to the host detection method according to one embodiment of the disclosure are as follows.

Priority 100: each network switch has only one flow entry with priority 100. With the SDN switch as an example, when the SDN switch is online, this priority 100 flow entry with a meter is added (step S301 of FIG. 3). A timeout period is exemplified as 180 seconds in the present example. The network switch receives one or more packets from a host within this timeout period. One of the objectives of this priority 100 flow entry is to resolve packets for acquiring a MAC address of the host (step S303 of FIG. 3).

Table 1 describes the priority 100 flow entry recorded in a memory of the network switch. Table 1 shows that this flow entry needs not to be matched on any field when there is no data in the match fields. One of the objectives of the priority 100 flow entry is to obtain a MAC address of the host. The action field shows that a packet matching this flow entry will be encapsulated in a packet-in message and this message will be sent to the SDN controller below a rate specified by a meter with ID 29. A timer inside the SDN switch counts time and a meter conducts metering within the timeout period (step S305 of FIG. 3). This flow entry will be removed upon timeout. However, the priority 100 flow entry can be reinstalled by the SDN controller. In an example, if the SDN switch is disconnected from the SDN controller, e.g., caused by malfunction of the SDN controller or the network, the priority 100 flow entry will be automatically removed due to timeout. Even though the connection between the SDN switch and the SDN controller is broken, the user-end host can still deliver the packets without being affected. Under this mechanism, the meter of the SDN switch can control the number of packets entering the central processor of the switch (step S307 of FIG. 3). Therefore, the loading of the central processor can be effectively reduced.

TABLE 1

| Priority | Match fields | Action | Hard timeout |
|---|---|---|---|
| 100 | | controller | 180 |
| | | meter ID: 29 | |

Table 2 describes a meter table of the priority 100 flow entry. The current example shows the meter table with meter ID 29 including a rate mode and a rate.

TABLE 2

| Meter ID | Rate mode | Rate |
|---|---|---|
| 29 | pktps | 8 |

Priority 310: each network switch only includes one priority 310 flow entry. One of the objectives of the present flow entry is to detect whether or not the one or more hosts are online and to obtain the MAC and IP addresses of every online host. In one embodiment, when the SDN switch is online, the SDN controller adds this second flow entry, used to resolve an ARP packet, to the memory of the SDN switch (step S301 of FIG. 3). When the SDN switch receives one or more ARP packets from one or more hosts, the SDN controller detects the packets and resolves them for comparison (step S303 of FIG. 3). A meter in the priority 310 flow entry is performed (step S305 of FIG. 3). The loading of the processor of the SDN switch can be reduced. Similarly, under this mechanism, the meter of SDN switch controls the number of packets entering the central processor of the switch (step S307 of FIG. 3) so as to reduce the loading of the central processor.

Table 3 describes a priority 310 flow entry that is used to match the ARP packets using ARP as its match fields. The action of this flow entry is sending packet-in messages to the controller below a rate specified by a meter with ID 29.

TABLE 3

| Priority | Match fields | Action | Hard timeout |
|---|---|---|---|
| 310 | ARP | controller | |
| | | normal | |
| | | meter ID: 29 | |

Table 4 describes a meter table with meter ID 29 including a rate mode pktps and a rate 8 of the priority 310 flow entry.

TABLE 4

| Meter ID | Rate mode | Rate |
|---|---|---|
| 29 | pktps | 8 |

Priority 110: each network switch has the same number of the priority 110 flow entries as the number of detected hosts (step S309 of FIG. 3). As exemplified by an SDN switch and an SDN controller, when the SDN switch receives an L2 packet matching the priority 100 flow entry or an ARP packet matching the priority 310 flow entry, the priority 110 flow entry will be written to a memory of the network switch. The data flow is under a byte counting by a counter. A counting result obtained by this counter can be used to detect whether the host is online or offline (step S311 of FIG. 3).

Table 5 describes a priority 110 flow entry that is used to match on the Source MAC Address using a Source MAC as its match fields and an action being a normal action.

TABLE 5

| Priority | Match fields | Action | Hard timeout |
|---|---|---|---|
| 110 | MAC | normal | |

Counter for flow entry with priority 110

Priority 330: each network switch has the same number of priority 330 flow entries as the number of detected hosts (step S313 of FIG. 3). When receiving the ARP packet matching the priority 310 flow entry from a specific host, this entry shows the host is online. This priority 330 flow entry is written to a memory of the network switch. If the IP address of the host is found to be changed but the MAC address is not changed according to the ARP packet matching the priority 310 flow entry, the priority 330 flow entry allows an updating of the mapping between the MAC address and the IP address (step S315 of FIG. 3). At the same time, the original priority 330 flow entry will be removed and a new 330 flow entry with the updated IP address is added. Therefore, the IP address can be obtained from the ARP packet matching the priority 310 flow entry. When the host changed IP address and the network switch receives the ARP packet with changed IP address matching the priority 310 flow entry, the sender protocol address of priority 330 flow would be changed. The loading of the central processor for dealing with these messages can thereby be reduced.

Table 6 describes a priority 330 flow entry that is used to match on a sender hardware address and a sender protocol address in the ARP packet generated by the user-end host. The match fields of the flow entry is the sender hardware address and the sender protocol address in the ARP packet. The action of the flow entry is a normal action.

TABLE 6

| Priority | Match fields | Action | Hard timeout |
|---|---|---|---|
| 330 | Sender' hardware | normal | |
| | address and sender | | |
| | protocol address | | |
| | recorded in ARP | | |
| | packet | | |

Priority 340: when the counting result of the priority 110 flow entries no longer changes or the counter is insufficient, the SDN controller adds the priority 340 flow entry. The SDN controller sends an ARP packet to the host. It is determined whether or not the host is online by checking if the controller gets any response of the ARP packet.

Table 7 describes a priority 340 flow entry. Every network switch has only one priority 340 flow entry that is used to match on a target hardware address in the ARP packet generated by a sender, e.g. the user-end host. The match fields of the priority 340 flow entry is the target hardware address of the ARP packet.

TABLE 7

| Priority | Match fields | Action | Hard timeout |
|---|---|---|---|
| 340 | Target hardware | controller | |
| | address in ARP packet | | |

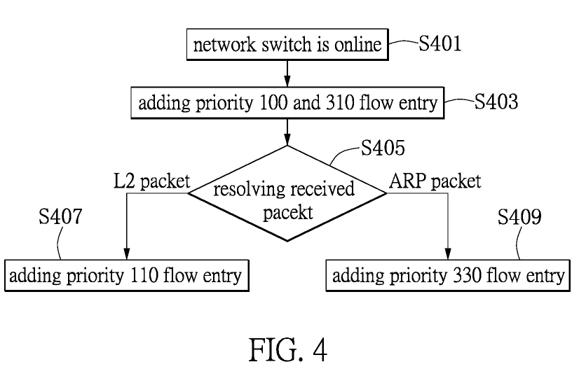

The operation of the host detection system of the disclosure is based on the host detection method performed in a network switch through the flow table. The host detection method can be referred to a flow chart in FIG. 4. The flow chart describes a process for detecting whether the host is online or not through packets.

This host detection method is based on the L2 packets and ARP packets obtained by a switch. When the network switch is online and in operation (step S401) as an SDN controller, a software procedure performed in the network switch stores the priority 100 and 310 flow entries into a memory of the network switch as one of the initial operations (step S403).

Next, the SDN controller resolves the packets obtained from each host (step S405). These packets can be L2 packets or ARP packets. In the meantime, if the received packet is the L2 packet that matches the priority 100 flow entry, a MAC address of the host is obtained. In step S407, the software procedure performed in the system adds the priority 110 flow entry to a memory of the SDN switch.

If the packet received by the SDN controller is an ARP that matches the priority 310 flow entry, such as in step S409, the priority 110 and 330 flow entries are configured to be added in the memory of the SDN switch.

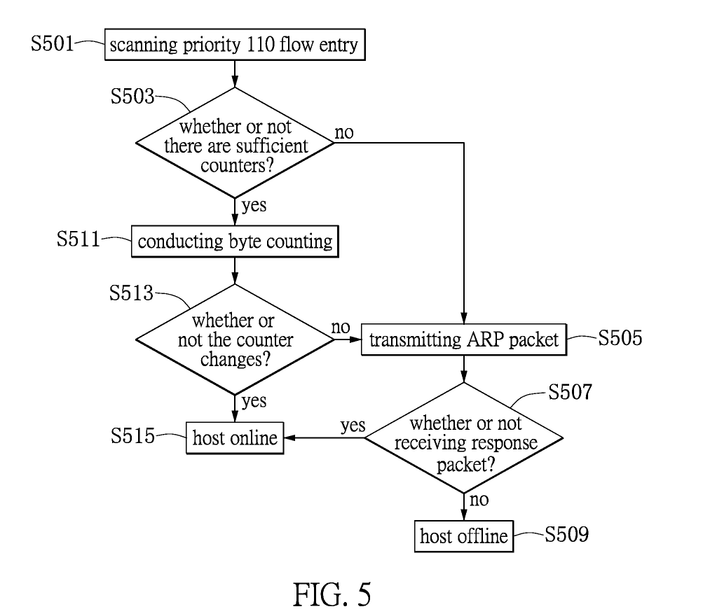

According to the above-mentioned mechanism, the host detection method for a network switch can be referred to a flow chart shown in FIG. 5. The host detection method is exemplarily performed under the architecture of the SDN switch and SDN controller.

The SDN switch is configured to resolve the received packets. In an initial process, the priority 100 and 310 flow entries are written in a memory of the network switch. The host is generally connected to a network via a wired or wireless connection. When the host generates the L2 packets, the SDN controller learns a MAC address. The priority 110 flow entry can be added to a flow table of the SDN switch in response to the detected host. Therefore, when the SDN switch receives the packets transmitted from the host, the packets are transferred to the SDN controller. The SDN controller detects if the host is online according to the priority 110 flow entry monitoring the packets transmitted by the host. However, if the network switch cannot retrieve the packets transmitted from the host, it indicates that the host is offline or that a failure of the communication port has occurred.

At the beginning of the method, under a normal circumstance, the SDN controller scans the priority 110 flow entry (step S501) and determines whether or not the SDN switch has a sufficient number of counters for the priority 110 flow entry (step S503). Each network switch has the same number of priority 110 flow entries as the number of detected hosts. Thus, when the SDN switch receives an L2 packet or an ARP packet, the priority 110 flow entry will be written to the SDN switch, allowing the SDN controller to determine whether or not the host is online by scanning the priority 110 flow entry. After scanning the priority 110 flow entry, the counting result obtained by the counter can be used to perform the host detection, e.g. detecting whether the host is online or not.

In step S503, if the SDN switch is found to not have enough counters, only the ARP packet can be relied upon to determine whether or not the host is online. In step S505, the SDN controller issues the ARP request packet through the SDN switch. The priority 340 flow entry can be added for matching the ARP response packets generated by the host. The ARP response packets are used to detect whether the host is online or not. For example, the ARP packet can be transferred to a specific host by a unicast process. Next, in step S507, the SDN controller resolves the received packet and determines if the SDN switch receives the ARP response packet from the host. If the SDN switch does not receive the ARP response packet from the host within the timeout period, the host is determined to be offline (step S509).

On the other hand, in step S503, if the SDN switch is determined to have sufficient counters, the SDN switch counts the data flow (step S511) and then determines whether or not the counted value obtained by the counter is changed (step S513). The host is determined to be online if the counted value is changed (step S515).

Further, it is determined that no data flow from the host is found from resolving the received packet if the counted value is not changed (no update) within a time threshold. In next step S505, the SDN controller issues the ARP request packet via the SDN switch. In step S507, the SDN controller determines whether or not the SDN switch receives the ARP response packet from the host. The host is determined to be online (step S515) if the ARP response packet from the host has been received. Otherwise, the host is determined to be offline if the SDN switch does not receive the ARP response packet (step S509).

Thus, the host detection method for a network switch is performed to determine whether the host is online or not through the flow entries in the network switch. Therefore, the loading of central processor of the network switch can be effectively reduced. For an SDN switch, the number of times that the memory is accessed for exchanging the packets between the SDN switch and the SDN controller can be effectively reduced so as to reduce the loading of processor.

A counter of the SDN switch can be associated with the priority 110 flow entry if the number of counters is sufficient. The SDN controller periodically accesses the counter, e.g. once in 10 minutes, and the counting result can be periodically obtained.

To sum up, the host detection method for a network switch can be applied to a network environment under the Software-Defined network. A host detection system can be implemented in the SDN network and the host detection method is operated in the SDN controller. The loading of central processor of the SDN switch, the messaging process between the SDN switch and the SDN controller, and the loading for processing the packets for the host can be reduced. It should be noted that the method utilizing a flow table, a meter, and a counter under OpenFlow protocol effectively detects the status of the host. The SDN can be more stable since the loading of the processor can be reduced.

It is intended that the specification and depicted embodiments be considered exemplary only, with a true scope of the invention being determined by the broad meaning of the following claims.

The foregoing description of the exemplary embodiments of the disclosure has been presented only for the purposes of illustration and description and is not intended to be exhaustive or to limit the disclosure to the precise forms disclosed. Many modifications and variations are possible in light of the above description.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method of host detection for a network switch, comprising:
adding a first flow entry with a meter and a second flow entry used to match ARP packets when an SDN switch goes online;
receiving packets from one or more hosts, and the SDN controller learning a MAC address from each host through the first flow entry or the second flow entry;
metering within a timeout period;
a meter of the SDN switch controlling an amount of the packets entering a central processor of the SDN switch for reducing loading of the central processor;
adding the same number of third flow entries as the number of the detected hosts, utilizing a counter to count the data flow of the hosts, and detecting if each host is online according to a counting result; and
adding the same number of fourth flow entries as number of the detected hosts for updating MAC address and IP address of each host;
wherein the host is detected to be online or offline through the first flow entry, the second flow entry, the third flow entry, the fourth flow entry and a fifth flow entry, so as to reduce loading of the central processor of the SDN switch.

2. The method according to claim 1, wherein the flow entries include:
a first flow entry: having no match fields;
a second flow entry: matching on ARP packet;
a third flow entry: matching on Source MAC Address;
a fourth flow entry: matching on Sender Hardware Address and Sender Protocol Address in ARP packet; and
a fifth flow entry: matching on Target Hardware Address in ARP packet.

3. The method according to claim 1, wherein the SDN switch only has the first flow entry and the second flow entry.

4. The method according to claim 3, wherein no packet of the host matches the first flow entry when the SDN switch disconnects from the SDN controller.

5. The method according to claim 4, wherein the flow entries are:
a first flow entry: having no match fields;
a second flow entry: matching on ARP packet;
a third flow entry: matching on Source MAC Address;
a fourth flow entry: matching on Sender Hardware Address and Sender Protocol Address in ARP packet; and
a fifth flow entry: matching on Target Hardware Address in ARP packet.

6. The method according to claim 3, wherein the first flow entry is removed once it is timed out.

7. The method according to claim 3, wherein the second flow entry is used to match ARP packets transmitted from the host, and a meter of the second flow entry is operated.

8. The method according to claim 1, wherein the third flow entry is written to a memory of the SDN switch when the SDN switch receives an L2 packet matching the first flow entry, or an ARP packet matching the second flow entry.

9. The method according to claim 8, wherein the flow entries are:
a first flow entry: having no match fields;
a second flow entry: matching on ARP packet;
a third flow entry: matching on Source MAC Address;
a fourth flow entry: matching on Sender Hardware Address and Sender Protocol Address in ARP packet; and
a fifth flow entry: matching on Target Hardware Address in ARP packet.

10. The method according to claim 1, wherein the fourth flow entry updates Sender Hardware Address and Sender Protocol Address in the match fields when the IP address of the detected host is found to be changed and the MAC address is not changed according to the ARP packet that matches the second flow entry.

11. The method according to claim 10, wherein the IP address of the host updated by the fourth flow entry is obtained from the ARP packet matching the second flow entry.

12. The method according to claim 11, wherein the flow entries are:
a first flow entry: having no match fields;
a second flow entry: matching on ARP packet;
a third flow entry: matching on Source MAC Address;
a fourth flow entry: matching on Sender Hardware Address and Sender Protocol Address in ARP packet; and
a fifth flow entry: matching on Target Hardware Address in ARP packet.

13. A system for host detection, comprising:
an SDN switch having a memory used to record a plurality of flow entries;
an SDN controller performing a host detection method for a network switch, wherein the SDN controller communicates with the SDN switch by an OpenFlow protocol and the method includes:
adding a first flow entry with a meter when the SDN switch is online, and adding a second flow entry that is used to match an ARP packet;
receiving packets from one or more hosts, and the SDN controller learning a MAC address of each host through the first flow entry or the second flow entry;
metering within a timeout period;
a meter of the SDN switch controlling an amount of packets entering a central processor of the SDN switch so as to reduce loading of the central processor of the SDN switch;
adding the same number of third flow entries as the number of detected hosts, utilizing a counter to count the data flow of the hosts, and detecting if each host is online according to a counting result; and
adding the same number of fourth flow entries as the number of detected hosts for updating MAC address and IP address of every host;
wherein the host is detected to be online or offline through the first flow entry, the second flow entry, the third flow entry, the fourth flow entry and a fifth flow entry, so as to reduce loading of the central processor of the SDN switch.

14. The system according to claim 13, wherein the flow entries are:
a first flow entry: having no match fields;
a second flow entry: matching on ARP packet;
a third flow entry: matching on Source MAC Address;
a fourth flow entry: matching on Sender Hardware Address and Sender Protocol Address in ARP packet; and
a fifth flow entry: matching on Target Hardware Address in ARP packet.

15. The system according to claim 13, wherein the SDN switch only has one first flow entry and one second flow entry ∘

16. The system according to claim 15, wherein the packet received from the host will not match the first flow entry when the SDN switch disconnects from the SDN controller.

17. The system according to claim 15, wherein the first flow entry is removed once it is timed out; the second flow entry is used to match ARP packets transmitted from the host, and a meter of the second flow entry is operated.

18. The system according to claim 17, wherein the flow entries are:
a first flow entry: having no match fields;
a second flow entry: matching on ARP packet;
a third flow entry: matching on Source MAC Address;
a fourth flow entry: matching on Sender Hardware Address and Sender Protocol Address in ARP packet; and
a fifth flow entry: matching on Target Hardware Address in ARP packet.

19. The system according to claim 13, wherein the third flow entry is written to a memory of the SDN switch when the SDN switch receives a layer two packet matching the first flow entry, or an ARP packet matching the second flow entry.

20. The system according to claim 19, wherein the flow entries are:
a first flow entry: having no match fields;
a second flow entry: matching on ARP packet;
a third flow entry: matching on Source MAC Address;
a fourth flow entry: matching on Sender Hardware Address and Sender Protocol Address in ARP packet; and
a fifth flow entry: matching on Target Hardware Address in ARP packet.
